(19) United States
(12) Patent Application Publication
(10) Pub. No.: US 2004/0110299 A1
(43) Pub. Date: Jun. 10, 2004

(54) Systems and methods to control humidity effects on sensor performance

(76) Inventor: Timothy Mark Sivavec, Clifton Park, NY (US)

Correspondence Address: CANTOR COLBURN, LLP, 55 GRIFFIN ROAD SOUTH, BLOOMFIELD, CT, 06002

(21) Appl. No.: 10/315,397

(22) Filed: Dec. 10, 2002

(51) Int. Cl. G01N 1/18

(52) U.S. Cl. 436/25; 436/125; 436/139; 436/177; 436/178; 436/181; 422/50; 422/68.1; 422/83

(57) ABSTRACT

A sensor system for controlling humidity effects on sensor performance comprising one or more sensor devices, a moisture reservoir disposed adjacent to the sensor array, wherein the moisture reservoir comprises desiccant materials operable for reversibly exchanging moisture with a sampled atmosphere, and a hydrophobic semi-permeable membrane permeable to volatile organic compounds and impermeable to water. A probe device for sampling groundwater comprising a sensor array, a moisture reservoir disposed adjacent to the sensor array, wherein the moisture reservoir comprises desiccant materials operable for extracting moisture from a sampled atmosphere, a hydrophobic semi-permeable membrane, a groundwater entry assembly, a power source, an analyte trap, and communications electronics. Methods for sampling a subaqueous environment using a probe device.

### STATEMENT REGARDING FEDERALLY SPONSORED RESEARCH OR DEVELOPMENT

The U.S. Government may have certain rights in this invention pursuant to contract DE AC26 number 01NT41188 awarded by the U.S. Department of Energy (DOE).

### BACKGROUND OF THE INVENTION

1. Field of the Invention

The present invention relates generally to the field of monitoring systems and sensor performance. More particularly, the present invention relates to a sensor system deployed in a monitoring probe, wherein the sensor system is operable for controlling the humidity levels that surround the sensor system.

2. Description of the Related Art

It is well known that many types of sensors are affected by humidity. These include surface acoustic wave (SAW) and quartz crystal microbalance (QCM) sensors. Reports on field testing of prototype instrumentation employing individual sensors and sensor arrays have suggested that the control of humidity may be at least as important to the accuracy of measurements as the inherent selectivity and sensitivity for target vapor analytes. Studies have demonstrated that temperature and/or atmospheric water vapor may influence the performance of SAW sensors by causing shifts in the baseline and/or by altering responses to the target vapor analytes. These studies also suggest that stand-alone vapor sensor arrays may have limited utility for environmental monitoring or for other applications subject to fluctuating ambient temperatures and humidity levels.

In many practical air-monitoring applications, organic vapors must be detected in the presence of relatively high ambient concentrations of water vapor. In SAW sensors, for example, responses depend upon changes in frequency accompanying the interaction of the target analyte(s) with a polymer coating. The adsorption of water vapor by the polymer coating may lead to large shifts in baseline frequencies. At high ambient humidity levels, the concentration of adsorbed water may be large enough to affect the interaction of the coating with the target vapors. It is also likely that a sensor such as a SAW sensor may need to be deployed in a variety of different applications in which the moisture level to be sampled varies. One example of such an application may be a probe operable for sampling groundwater containing target volatile organic compounds (VOCs) and vapor containing similar target VOCs.

In a well-controlled environment, it may be necessary to periodically reestablish a baseline or instrument zero by drawing a filtered air sample past a sensor device. Zellers et al. (Analytical Chem. 1996, 68, 2409-2418) has shown that a change in relative humidity of less than 0.1 percent is enough to cause significant error in the responses of a polymer-coated SAW, even when baseline and sample streams are compared. Large humidity differences between calibration and sampling conditions leads to errors in the identification and quantification of target vapors.

Therefore, a need exists for a system to control the humidity effects on sensor performance. The system should be effective for a wide variety of sensor types including surface acoustic wave sensors.

### BRIEF SUMMARY OF THE INVENTION

In one aspect, the present invention comprises a system for controlling humidity effects on sensor performance. The system comprises a headspace, a sensor array comprising one or more chemical sensors disposed within the headspace operable for sensing volatile organic compounds, a moisture reservoir disposed adjacent to the sensor array comprising dessicant materials operable for reversibly exchanging moisture with a sampled atmosphere, and a hydrophobic semi-permeable membrane operable for allowing only the volatile organic compounds to diffuse into the headspace comprising the sensor array. In another aspect, the one or more chemical sensors comprise surface acoustic wave and quartz crystal microbalance sensors. Other sensor types include electrochemical sensors, chemiresistors, metal oxide semiconductor sensors and catalytic bead sensors. In a further aspect, the semi-permeable membrane comprises polytetrafluoroethylene. In a still further aspect, the moisture reservoir comprises silica gel, porous plastic resins, solutions of inorganic salts, or other solid hygroscopic materials.

In a still further aspect, the sensor system of the present invention is operable for detecting volatile organic compounds in groundwater, wherein the volatile organic compounds comprise chlorinated solvents, hydrocarbons, and other volatile organic compounds including polar and non-polar volatile organic compounds. In a still further aspect, the volatile organic compounds diffuse through the semi-permeable membrane and moisture reservoir while the moisture reservoir provides a buffering of the relative humidity level of a sampled atmosphere, thereby affording a stable and reduced relative humidity environment to the sensor array.

In a still further aspect, the present invention comprises a probe device for sampling groundwater, wherein the probe device is placed in a subaqueous environment, such as a well. The probe device comprises a sensor array comprising one or more chemical sensors, a moisture reservoir comprising hygroscopic disposed adjacent to the sensor array, a hydrophobic semi-permeable membrane, a groundwater entry assembly, a power source, an analyte trap, control electronics and communications electronics. In a still further aspect, the probe device may be connected to a deployment structure via a support line, wherein the deployment structure is operable for raising/lowering the probe device to pre-determined sampling positions. In a still further aspect, volatile organic compounds may be monitored in the vapor phase in the well above the water column, where the relative humidity is near one-hundred percent.

In a still further aspect, the present invention comprises a method for sampling groundwater comprising providing a hydrophobic semi-permeable membrane, the semi-permeable membrane being permeable to volatile organic compounds and impermeable to water, providing a moisture reservoir comprising a desiccant material for reversibly exchanging moisture with a sampled atmosphere, providing a sensor array comprising one or more sensor devices, placing the semi-permeable membrane in contact with the groundwater, allowing the volatile organic compounds to diffuse through the semi-permeable membrane, allowing the volatile organic compounds to diffuse through the moisture reservoir, allowing the moisture reservoir to reach a state of equilibrium in humidity level with the sampled atmosphere, and sensing the volatile organic compounds with the one or more sensor devices.

In a still further aspect, the present invention comprises a method for sampling groundwater in a subaqueous environment, such as an in-well environment. The method comprises providing a groundwater sampling probe device comprising a sensor array comprising one or more sensor devices, a moisture reservoir disposed adjacent to the sensor array, a hydrophobic semi-permeable membrane, a groundwater entry assembly, a power source, an analyte trap, and communications electronics. The method further comprises placing the probe device subaqueously, placing the semi-permeable membrane in contact with the groundwater, allowing volatile organic compounds to diffuse through the semi-permeable membrane, allowing the volatile organic compounds to diffuse through the moisture reservoir, allowing the moisture reservoir to reach a state of equilibrium in humidity level with a sampled atmosphere, and sensing the volatile organic compounds with the one or more sensor devices.

### BRIEF DESCRIPTION OF THE DRAWINGS

A variety of specific embodiments of the invention will now be illustrated with reference to the Figures. In these Figures, like elements have been given like numerals.

FIG. 1 is a schematic diagram illustrating a sensor system operable for controlling humidity effects on sensor performance in accordance with an exemplary embodiment of the present invention;

FIG. 2 is a table listing suitable examples of semi-permeable membrane materials deployed in the sensor system of FIG. 1;

FIG. 3 is an illustrative view of the sensor system of FIG. 1 deployed in a groundwater sampling probe device in accordance with an exemplary embodiment of the present invention; and

FIG. 4 is a table listing suitable examples of membrane support materials deployed in the probe device of FIG. 3.

### DETAILED DESCRIPTION OF THE INVENTION

As required, detailed embodiments of the present invention are disclosed herein, however, it is to be understood that the disclosed embodiments are merely exemplary of the invention that may be embodied in various and alternative forms. Specific structural and functional details disclosed herein are not to be interpreted as limiting, but merely as a basis for the claims as a representative basis for teaching one skilled in the art to variously employ the present invention. The systems described below apply to surface acoustic wave (SAW) sensors deployed in an in-well monitoring system, however, in principle also apply to any sensor affected by humidity.

In various embodiments, systems to control the humidity levels that surround a chemical sensor are disclosed. A wide variety of sensor types including SAW and quartz crystal microbalance (QCM) sensors are sensitive to changes in the humidity of an ambient or sampled atmosphere. Humidity changes may lead to excessively high or low concentrations of target analyte(s) being measured, and to the triggering of false responses or to the suppression of states of response when a response should have been triggered.

The sensor system, as embodied by the invention, may quickly and accurately determine the presence and concentrations of analyte materials, such as, but not limited to chlorinated solvents, hydrocarbons, and other volatile organic compounds including polar and non-polar VOCs in water samples, such as groundwater. The description of the invention refers to the materials as VOCs in the water samples, however, this description is merely exemplary of materials to be detected in the samples, and is not intended to limit the invention in any manner.

A sensor array is illustrated throughout the several figures. A single sensor may exhibit a non-specific response in some sensing applications. Thus, identification and quantification of target VOCs may be adversely influenced. To overcome this potential adverse influence, an array of sensors is provided, in which at least one of the sensors in the array comprises a SAW sensor. Sensor arrays permit pattern recognition from the data collected that reflects the nature, property and quantity of the target VOCs. The number of sensors in the sensor array may be one or more, in which the number of sensors is usually dependent on various application criteria. These application include, but are not limited to, the type of desired sensor response, complexity of analyzed mixture, concentration of vapor or target VOCs, signal levels produced by each sensor, noise levels produced by each sensor, similarity of response patterns, combinations thereof and other sensor related factors.

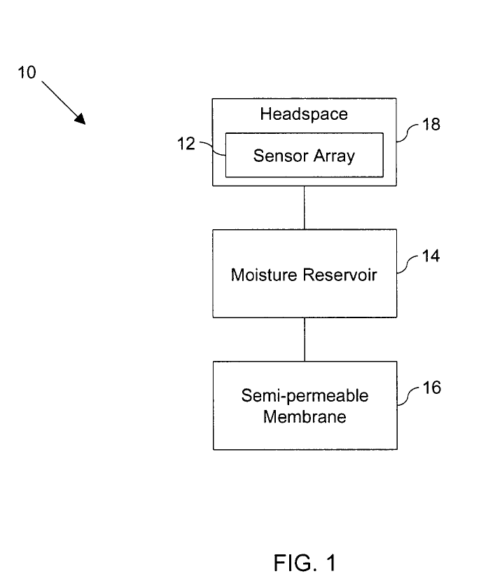

Referring now to the figures, FIG. 1 is a first, illustrative, and non-limiting embodiment of the present invention. Sensor system 10 is operable for controlling the effects of humidity on sensor performance constructed in accordance with the present invention. The sensor system 10 comprises a sensor array 12 comprising one or more chemical sensors. The sensor array 12, as embodied by the invention, comprises any number of appropriate sensors and sensor substrate, such as, but not limited to, acoustic wave sensors that include, but are not limited to, SAW sensors and QCM sensors. These sensors are chemical sensors and find use in many diverse detection applications including monitoring various target analytes.

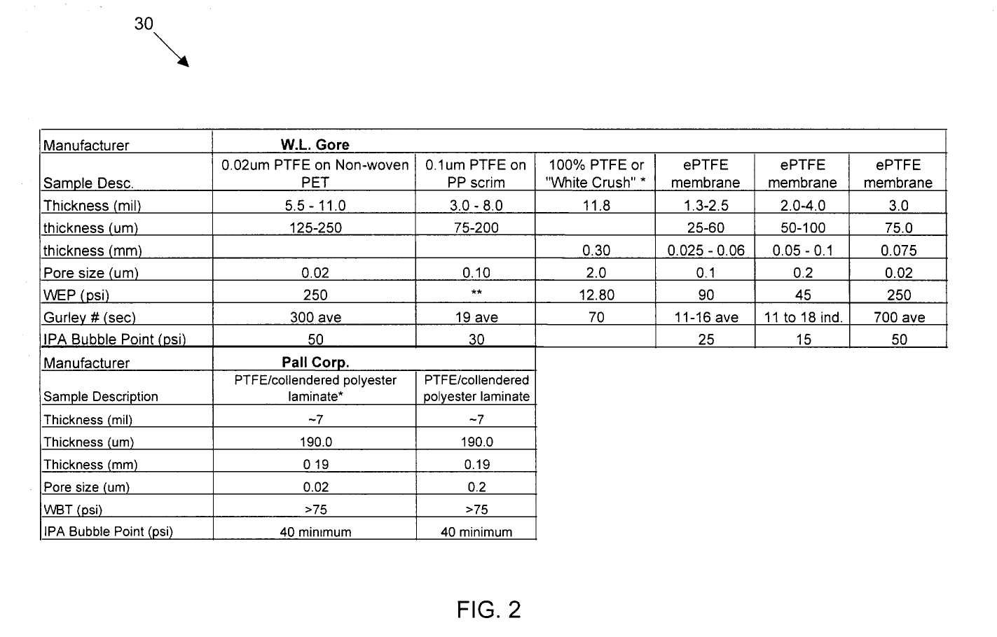

The sensor array 12 is coupled to the environment that it is sampling via a moisture reservoir 14 and a semi-permeable, hydrophobic membrane 16 (hereinafter “semi-permeable membrane”). The semi-permeable membrane 16 serves to allow only volatile organic compounds (VOCs) to diffuse into the headspace 18 that contains the sensor array 12. The semi-permeable membrane 16 may comprise any appropriate material, such as, but not limited to, silicone, low-density polyethylene, Mylar®, Teflon® and Nafion® tubing. Examples of suitable semi-permeable membrane 16 materials are listed generally in FIG. 2 at 30.

Referring again to FIG. 1, the diffusion rates are typically quite fast with common semi-permeable membranes 16 such as Teflon® or PTFE, and may provide near real-time monitoring capability. To avoid incorrect measurements in the case of rapid changes in atmospheric humidity or when high humidity levels are encountered, the moisture reservoir 14 is incorporated between the semi-permeable membrane 16 and the sensor array 12. Contact of the atmosphere or sample atmosphere with the moisture reservoir 14 provides a buffering or damping of the relative humidity level, thereby affording a stable and reduced relative humidity environment to the sensor array 12. The moisture exchange is a reversible process and the water vapor initially collected within the moisture reservoir 14 may be discharged out of the sensor system 10 using Nafion® tubing or membranes.

The moisture reservoir 14 comprises moisture-permeable materials that provide large surface areas for rapid humidity exchange. The dimensions of the moisture reservoir 14 should be set to provide adequate air/gas mixing and to provide sufficient moisture storage capacity. The larger the moisture reservoir 14, the larger the total amount of hygroscopic material present. The moisture reservoir 14 may contain solutions of inorganic salts or solid hygroscopic materials such as silica gel or porous plastic resins used to extract moisture from the atmosphere or sampled atmosphere until a sufficient amount of moisture is stored in the reservoir 14 and a state of equilibrium is reached. The moisture reservoir 14 is intended to reach a state of equilibrium in humidity with the sampled atmosphere. Many such reservoir 14 substances offer large moisture storage capacities such that sensor array 12 measurements may be made long before equilibrium is achieved. If the humidity in the sample atmosphere is increasing, moisture is removed from the area surrounding the moisture reservoir 14. Conversely, the moisture reservoir 14 releases moisture when the humidity of the sampled atmosphere is decreasing. The moisture reservoir 14 is used to locally counteract changes in humidity.

In the preferred embodiment, silica gel beads with added desiccant are used in the moisture reservoir 14. Silica gel is easy to package, and unlike salts and acids, does not dissolve. The amount of beads and number of layers may vary depending upon the application and the sizes of the beads used. In general, the larger the bead size, the more layers needed. Silica gel is widely available as mesh granules, for example, −6+18 mesh or −3+8 mesh, with an indicator (cobalt chloride) that changes from blue to pink as follows: blue when activated; violet when ten percent moisture absorbed; pink when nineteen percent moisture absorbed; and pale pink when twenty-eight percent moisture absorbed. The presence of an indicator allows for the easy replacement when the desiccant is saturated. Silica gel without added desiccant is also widely available in a much wider particle size range, from mesh powder, −70+230 mesh, to granular, 3-9 mesh, for example. Silica gel or any other desiccant materials most efficiently absorb water vapor that permeates through a semi-permeable barrier such as PTFE, if it is deposited in a packed bed form across the entire surface of the semi-permeable membrane.

The sensor system 10 is designed so that water vapor has to pass through a torturous pathway through the desiccant material to remove VOCs that are sensed by the sensor array 12. VOCs that diffuse through the membrane are measured, while water vapor does not. The VOCs are sensed by the sensor array 12 which includes one or more SAW sensors. Polymer-coated SAW vapor sensors have been developed for providing selective determinations of organic vapors. In gas sensor technology, SAW sensors show the maximum sensitivity possible in the detection of trace gases. A selectivity adsorbing layer of a SAW sensor permits the sensor to detect a target analyte or other compound. When the selectivity adsorbing layer on the surface of the sensor is influenced by gas molecules, it reacts by shifting its resonant frequency. The sensor exhibits a changed oscillation frequency due to mass changes when contacted with material, for example a vapor, that includes the target analyte. The mass increase of the sensor occurs through a solubility interaction between the polymeric film and vapor, which includes the target analyte. This interaction produces a frequency shift (or change) of oscillations at the resonance frequency. Therefore, the change in oscillation frequency that is attributed to the target compound may be accurately detected.

The manufacturing of a SAW sensor may be based on a CMOS process. The circuit may comprise control and evaluation electronics of the SAW sensor as well as a temperature control. The resonant frequency may depend on the temperature of the SAW sensor. The manufacturing process of the SAW sensor may be completed by implementing piezoelectric layers, membranes based on Microsystems technology, and gas sensitive layers.

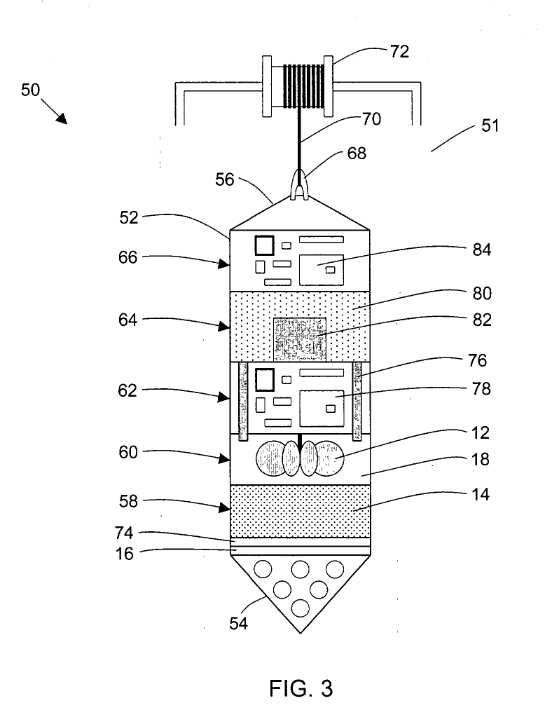

Referring now to FIG. 3, shown generally at 50, is one embodiment of a sampling device 50 deploying the sensor system 10 of the present invention, and which illustrates conceptually, the preferred elements contained therein. A sampling probe device 50 containing the sensor system 10 may be used to determine the presence and concentration of VOCs and other contaminants in groundwater, such as the groundwater of a well 51. The probe device 50 is used subaqueously, thus accomplishing its objectives without requiring the pumping or bailing of water samples from within the well 51. It has been found that water immediately adjacent to a well screen can be representative of an aquifer without having to purge, and may even be more favorable than samples achieved after purging due to the sampling bias that may result from the purging itself. In another embodiment, volatile organic compounds may be monitored in the vapor phase in the well above the water column, where the relative humidity is near one-hundred percent.

This embodiment of the probe device 50 includes a housing 52 having a generally cylindrical shape and a first perforated end 54, a second closed end 56, and which includes an internal cavity located therein. The internal cavity is subdivided into first, second, third, fourth and fifth chambers 58, 60, 62, 64 and 66, with the first chamber disposed adjacent to the first end 54 and the fifth chamber disposed adjacent to the second end 56. Chambers two, three and four 60, 62 and 64 are disposed in consecutive order between the first and fifth chambers 58, 66. A support line 70, for example a cable, is securely connected to the second end 56 and to a probe device deployment structure 72. A winch is shown in FIG.2 as one example of a deployment structure 72, however, any structure may be used that is capable of deploying the probe device 50 into a body of water, such as a crane, hoist, etc. The mechanism for attaching the support line 70 to the second end 56 of the probe device 50 comprises any appropriate fastener capable of supporting the weight of the probe device 50. The support line 70 and deployment structure 72 are operable for lowering/raising the probe device 50 into/out-of the well 51.

The first end 54 of the probe device 50 comprises a groundwater passageway in direct contact with the groundwater sample to be monitored. In one example, the first end 54 is made of a perforated stainless steel material and forms a water entry assembly. The water passageway may be capable of user-controllable flow or programmed (via a computer algorithm) flow. The groundwater is contained within, and preferably substantially fills, the passageway. The groundwater contains the VOCs to be monitored.

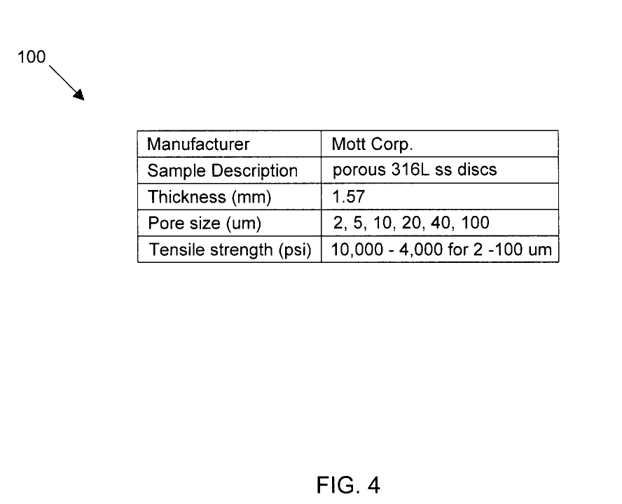

The probe device 50 comprises the semi-permeable, hydrophobic membrane 16 described above disposed directly above and adjacent to the first end 54, which may comprise low-density polyethylene. Alternatively, the semipermeable membrane 16 may comprise any appropriate material, such as, but not limited to, silicone, polyethylene, Mylar®, Teflon® and Nafion® tubing. The semi-permeable membrane 16 material is selected so that VOCs may diffuse therethrough, with the semi-permeable membrane 16 material being generally impermeable to water. This semi-permeable membrane 16 feature makes the membrane 16 effective in protecting the probe device 50 if exposed to at least one of groundwater and heavy particulate. The impermeable feature also expands the utility of the probe device 50 into areas and applications where environmental considerations previously limited use. The semi-permeable membrane 16 may further comprise a seal disposed on both ends. The seal may be formed by any appropriate sealing function, such as but not limited to, an impulse heat seal or an adhesive seal. The semi-permeable membrane 16 is supported by a membrane support 74, such as a stainless steel disc. Examples of suitable membrane support 74 materials are listed generally in FIG. 4 at 100.

Referring again to FIG. 3, as previously described above, the first chamber 58 comprises the moisture reservoir 14 that includes a desiccant material operable for extracting moisture from the atmosphere or sampled atmosphere away from the sensor array 12. The dimensions of the moisture reservoir 14 should be set to provide adequate air/gas mixing and to provide sufficient moisture storage capacity. The moisture reservoir 14 may be partially or completely filled. Contact of the atmosphere or sample atmosphere with the moisture reservoir 14 provides a buffering or damping of the relative humidity level, thereby affording a stable and reduced relative humidity environment to the sensor array 12. The moisture exchange in the moisture reservoir 14 is a reversible process, and the water vapor initially collected within the moisture reservoir 14 may be removed to other sorbents within the probe device 50, as will be described below, or even discharged out of the probe device housing 52 using Nafion® tubing or membranes.

Specific inorganic salts and aqueous solutions (not completely saturated) are used to set a target maximum humidity level. Examples of salts and percent relative humidity targets at 25 degC. include: LiCl, 11 percent relative humidity; CaCl₂, 29 percent relative humidity; Nal, 39 percent relative humidity; NH₄NO₃, 62 percent relative humidity; NaCl, 75 percent relative humidity; and KNO₃, 92 percent relative humidity. Silica gel, porous polymer resins and pelletized inorganic salts such as CaSO₄ (Drierite) may also be used to absorb and store moisture.

The second chamber 60 comprises the sensor array 12 and sensor headspace 18. As stated above, the sensor array 12 comprises one or more polymer-coated SAW sensors operable for detecting VOCs in the groundwater. Typically, a sensor is provided with a chemically sensitive film that is applied onto a surface of the sensor, for example onto the surface of the sensor's crystal. Interactions of the film with a VOC to be detected induce a change in at least one of the mass and visco-elastic properties of the film. This change is measured as a shift of the resonance frequency of the sensor's crystal and is related to the concentration of the VOC. For the detection of VOCs of differing nature, the coating and VOC interactions include, but are not limited to, hydrogen bonding, π-stacking, acid-base, electrostatic and size/shape recognition.

Each sensor's configuration, materials, and other characteristics vary to define operational characteristics, resonance frequencies, and boundaries for the sensor. For example, differing piezoelectric materials for a sensor substrate operate differently, and thus define the sensors operational boundaries and characteristics. Therefore, if a sensor comprises a quartz crystal microbalance (QCM) as a sensor substrate, the sensor operates by propagating mechanical oscillations generally perpendicularly between parallel faces of a thin, quartz-crystal piezoelectric element. If a sensor comprises a surface acoustic wave (SAW) device as a sensor substrate, mechanical oscillations are propagated in substantially up-and-down undulations at a radio frequency (RF) along the surface of a thin, quartz-crystal piezoelectric element.

The third chamber 62 comprises recirculating pumps/tubing 76 for headspace 18 cleaning and probe device electronics 78. The pumps/tubing 76 provide a gas diffusion path from the sensor headspace 18 out of the probe device 50 or to an analyte trap subassembly 80, which is described below. It may be necessary to clear all gas from the sensor headspace 18 for the purpose of zeroing or resetting the sensor array 12. It may also be useful to have the sensor probe device 50 make multiple measurements at several different subaqueous elevations in a single subaqueous mission. Cleaning the headspace 18 between measurements would be necessary in this application. During a purge cycle, a small motorized pump may pull air from the headspace chamber 18, and push it into the analyte trap assembly 80. Granulated activated carbon is an example of the trap media. The analyte trap assembly will absorb the volatile organic compounds from the sensor headspace 18 and return clean air to the headspace 18. Small spring-operated check valves located at the sensor headspace's air inlet and outlet 76 isolate the sensor headspace chamber 18 from the pump when the purge cycle ends. During a purge cycle, the sensor array's output may be monitored as a means of providing feedback on the effectiveness of the purging process. The pump motors are available with very low power consumption, thereby making it feasible to conduct purging cycles often. The probe device electronics 78 are operable for controlling the sensor array 12, feedback as well as other controls. For example, some types of control may require only VOC detection signals while others require detection, concentration, temperature, etc.

The fourth chamber 64 comprises an analyte trap subassembly 80 and a power supply 82, such as a battery. The analyte trap subassembly 80 preferably includes an input for accepting vapor, a collection trap vessel and an output. The interior of the collection trap vessel is equipped with a quantity of trapping material suitable for circulating and cleaning out the air. The output may be open such that it may act as a vent to the ambient atmosphere. To minimize the failure of the analyte trap subassembly 80 and the sensor system 10 due to particulates, a filter may be provided in the input so as to prevent the flow of particulates from the analyte trap subassembly 80 downstream to the electronics 78, sensor array 12 and moisture reservoir 14. The analyte trap 14 may comprise activated carbon and desiccant materials that are effective at removing organic compounds, such as VOCs, pesticides, benzene, chlorine, some metals and water vapor. The activated carbon may be packaged in filter cartridges that are inserted into the probe device 50. Vapor needing treatment passes through the cartridge, contacting the activated carbon. Activated carbon filters may eventually become fouled with contaminants and may lose their ability to adsorb pollutants, at which time they should be replaced. The analyte trap subassembly 80 may use either granular activated carbon (GAC) or powdered block carbon. Although both are effective, block activated carbon filters are found to be more effective in removing halogenated organic compounds. The amount of activated carbon in the subassembly 80 affects the amount and rate of pollutant removal. More carbon means more capacity for chemical removal and, therefore, leads to longer subassembly 80 lifetime. Particle size also affects the rate of removal, smaller activated particles generally show higher adsorption rates.

The fifth chamber 66 comprises a charging subassembly and communication electronics 84. A transmitter/receiver may send/receive data signals from the sensor array 12 to a data collection memory of the probe device 50 or to a remote monitoring site. The remote monitoring site may receive a vertical profile of the VOCs in the well groundwater including depth versus concentration charts. The transmitter/receiver may send/receive these signals via any appropriate communication link known in the art. The communication electronics 84 may be programmable and instruct the deployment structure 72 to raise/lower the probe device 50 to any pre-determined sampling position. The charging subassembly may include a solar charger or any other charging means known in the art operable for supplying power to the probe device 50.

While the components of the probe device 50 have been discussed in a particular arrangement, it is envisioned that alternative arrangements may be practiced without affecting the functions of the probe device 50.

The method of sampling groundwater contaminants, as embodied by the invention, comprises positioning the probe device 50 subaqueously in the well 51 containing groundwater. The probe device 50 is positioned in the well 51 such that that once the probe device 50 is in contact with the contaminated groundwater, contaminants can begin to diffuse into the entry cone through the semi-permeable membrane 16 into the moisture reservoir 14 and eventually into the headspace 18 of the second chamber 60. Air that is displaced from the probe device 50 moisture reservoir 14 and headspace 18 diffuses into the groundwater, as contaminants from the groundwater diffuse into the probe device 50. Water vapor is captured and stored in the desiccant material of the moisture reservoir 14. The desiccant over time may become saturated. Once sampling is complete, the probe device 50 is raised up and out of the well 51 using support line 70. The probe device 50 may be purged to zero it and remove the VOCs.

It is apparent that there have been provided, in accordance with the systems and methods of the present invention, systems and methods for controlling humidity effects on sensor performance. Although the systems and methods have been described with reference to preferred embodiments and examples thereof, other embodiments and examples may perform similar functions and/or achieve similar results. All such equivalent embodiments and examples are within the spirit and scope of the present invention and are intended to be covered by the following claims.

What is claimed is:

1. A sensor system, comprising:
a headspace;
a sensor array comprising one or more chemical sensors disposed within the headspace operable for sensing volatile organic compounds;
a moisture reservoir disposed adjacent to the sensor array, wherein the moisture reservoir comprises desiccant materials operable for extracting moisture from a sampled atmosphere; and
a hydrophobic semi-permeable membrane operable for allowing only the volatile organic compounds to diffuse into the headspace comprising the sensor array.

2. The sensor system of claim 1, wherein the one or more chemical sensors are selected from the group consisting of surface acoustic wave, quartz crystal microbalance sensors, electrochemical sensors, chemiresistors, metal oxide semiconductor sensors and catalytic bead sensors.

3. The sensor system of claim 1, wherein the semi-permeable membrane comprises polytetrafluoroethylene.

4. The sensor system of claim 1, wherein the moisture reservoir comprises silica gel or porous plastic resins operable for extracting moisture from the sampled atmosphere.

5. The sensor system of claim 1, wherein the volatile organic compounds comprise chlorinated solvents, hydrocarbons, and other volatile organic compounds including polar and non-polar volatile organic compounds.

6. The sensor system of claim 1, wherein the moisture reservoir provides a buffering of the relative humidity level of the sampled atmosphere, thereby affording a stable and reduced relative humidity environment to the sensor array.

7. The sensor system of claim 6, wherein moisture exchange within the moisture reservoir is a reversible process.

8. A probe device for sampling groundwater, comprising:
a headspace;
a sensor array comprising one or more chemical sensors disposed within the headspace operable for analyte sensing;
a moisture reservoir disposed adjacent to the sensor array, wherein the moisture reservoir comprises desiccant materials operable for extracting moisture from a sampled atmosphere;
a hydrophobic semi-permeable membrane operable for allowing only the analyte to diffuse into the headspace comprising the sensor array;
a groundwater entry assembly;
a power source; and
an analyte trap.

9. The device of claim 8, further comprising:
charging electronics operable for recharging the power source;
communication electronics;
a support line connected to a deployment structure operable for raising/lowering the probe device to pre-determined sampling positions; and
control electronics operable for controlling at least one of the sensor array, a recirculating pump, the power source, the groundwater entry assembly, the charging electronics, the communication electronics, and the deployment structure.

10. The device of claim 8, wherein the device is used subaqueously in a well.

11. The device of claim 8, wherein the semipermeable membrane comprises polytetrafluoroethylene.

12. The device of claim 8, wherein the moisture reservoir comprises silica gel or porous plastic resins operable for extracting moisture from the sampled atmosphere.

13. The device of claim 8, wherein the analyte is selected from the group consisting of chlorinated solvents, hydrocarbons, and other volatile organic compounds including polar and non-polar volatile organic compounds.

14. The device of claim 8, wherein the moisture reservoir provides a buffering of the relative humidity level of the sampled atmosphere, thereby affording a stable and reduced relative humidity environment to the sensor array.

15. The device of claim 8, wherein the device may be used to monitor the analyte in the vapor phase in the well above the water column.

16. A method for sampling groundwater, comprising:
providing a hydrophobic semi-permeable membrane, the semi-permeable membrane being permeable to volatile organic compounds and impermeable to water;
providing a moisture reservoir comprising a desiccant material for reversibly exchanging moisture with a sampled atmosphere;
providing a sensor array comprising one or more sensor devices;
placing the semi-permeable membrane in contact with the groundwater;
allowing the volatile organic compounds to diffuse through the semi-permeable membrane;
allowing the volatile organic compounds to diffuse through the moisture reservoir;
allowing the moisture reservoir to reach a state of equilibrium in humidity level with the sampled atmosphere; and
sensing the volatile organic compounds with the one or more sensor devices.

17. The method of claim 16, wherein the one or more sensor devices are selected from the group consisting of surface acoustic wave, quartz crystal microbalance sensors, electrochemical sensors, chemiresistors, metal oxide semiconductor sensors and catalytic bead sensors.

18. The method of claim 16, wherein the semi-permeable membrane comprises polytetrafluoroethylene.

19. The method of claim 16, wherein the moisture reservoir comprises silica gel or porous plastic resins.

20. The method of claim 16, wherein the volatile organic compounds comprise chlorinated solvents, hydrocarbons, and other volatile organic compounds including polar and non-polar volatile organic compounds.

21. The method of claim 16, wherein the moisture reservoir provides a buffering of the relative humidity level of the sampled atmosphere, thereby affording a stable and reduced relative humidity environment to the sensor array.

22. A method for sampling groundwater, comprising;
providing a groundwater sampling probe device comprising a sensor array comprising one or more sensor devices, a moisture reservoir disposed adjacent to the sensor array, a hydrophobic semi-permeable membrane, a groundwater entry assembly, a power source, an analyte trap, and communications electronics;
placing the probe device subaqueously;
placing the semi-permeable membrane in contact with the groundwater;
allowing volatile organic compounds to diffuse through the semi-permeable membrane;
allowing the volatile organic compounds to diffuse through the moisture reservoir;
allowing the moisture reservoir to reach a state of equilibrium in humidity level with a sampled atmosphere; and
sensing the volatile organic compounds with the one or more sensor devices.

23. The method of claim 22, wherein the moisture reservoir comprises dessicant materials operable for reversibly exchanging moisture with the sampled atmosphere selected from the group consisting of silica gel, porous plastic resins, solutions of inorganic salts, and solid hygroscopic materials.

24. The method of claim 22, wherein the one or more sensor devices are selected from the group consisting of surface acoustic wave, quartz crystal microbalance sensors, electrochemical sensors, chemiresistors, metal oxide semiconductor sensors and catalytic bead sensors.

25. The method of claim 22, wherein the semi-permeable membrane comprises polytetrafluoroethylene.

26. The method of claim 22, wherein the volatile organic compounds comprise chlorinated solvents, hydrocarbons, and other volatile organic compounds including polar and non-polar volatile organic compounds.

27. The method of claim 22, wherein the moisture reservoir provides a buffering of the relative humidity level of the sampled atmosphere, thereby affording a stable and reduced relative humidity environment to the sensor array.

28. The method of claim 22, wherein the probe device may be placed in the vapor phase in the well above the water column.
